(19) United States
(12) Patent Application Publication
(10) Pub. No.: US 2016/0076712 A1
(43) Pub. Date: Mar. 17, 2016

(54) LIGHT EMITTING APPARATUS, LIGHTING LIGHT SOURCE, AND LIGHTING APPARATUS

(71) Applicant: PANASONIC INTELLECTUAL PROPERTY MANAGEMENT CO., LTD., Osaka (JP)

(72) Inventors: Koji OMURA, Osaka (JP); Yasuharu UENO, Osaka (JP); Tomoya IWAHASHI, Osaka (JP)

(73) Assignee: PANASONIC INTELLECTUAL PROPERTY MANAGEMENT CO., LTD., Osaka (JP)

(21) Appl. No.: 14/829,715

(22) Filed: Aug. 19, 2015

(30) Foreign Application Priority Data
Sep. 11, 2014 (JP) 2014-185622

(51) Int. Cl. F21K 99/00; F21V 31/04; F21V 23/00; F21V 9/16

(52) U.S. Cl. CPC F21K 9/56; F21V 9/16; F21V 31/04; F21V 23/001; F21Y 2101/02

(57) ABSTRACT

Light emitting apparatus includes: substrate; red LED chip on substrate; blue LED chip on substrate, blue LED chip being connected in series with red LED chip and having an emission color different from red LED chip; and second sealing member that includes green phosphor and yellow phosphor and seals at least blue LED chip, and light-emission by red LED chip, blue LED chip, green phosphor, and yellow phosphor produces white light.

### CROSS REFERENCE TO RELATED APPLICATION

This application claims the benefit of priority of Japanese Patent Application Number 2014-185622, filed Sep. 11, 2014, the entire content of which is hereby incorporated by reference.

### BACKGROUND OF THE INVENTION

1. Field of the Invention

The present disclosure relates to a light emitting apparatus, etc, including a light emitting element on a substrate.

2. Description of the Related Art

A semiconductor light emitting element, such as a light emitting diode (LED), is widely utilized as a highly efficient, space-saving light source in various lighting apparatuses for lighting applications, display applications, etc.

A COB (chip on board) light emitting apparatus (a light emitting module) in which an LED mounted on a substrate is sealed with a translucent resin, and a light emitting apparatus using a packaged SMD (surface mount device) light emitting element are also known (see Japanese Unexamined Patent Application Publication No. 2011-146640, for example).

### SUMMARY OF THE INVENTION

In a light emitting apparatus, there are cases where plural types of LEDs each having different emission color are used for the purposes of enhancing color rendering of the light emitted from the light emitting apparatus. In such a light emitting apparatus, when the plural types of LEDs are connected in series, the light output (brightness) of the plural LEDs cannot be adjusted separately for each type. Thus, there is a difficulty in adjusting the chromaticity of the light emitting apparatus to match a target chromaticity.

In view of this, the present disclosure provides a light emitting apparatus and the like which facilitates chromaticity adjustment.

A light emitting apparatus according to an aspect of the present disclosure is a light emitting apparatus including: a substrate; a first light emitting element on the substrate; a second light emitting element on the substrate, the second light emitting element being connected in series with the first light emitting element and having an emission color different from the first light emitting element; and a sealing member that includes at least two types of phosphors and seals at least the second light emitting element, wherein the at least two types of phosphors have different peaks in emission spectra within a predetermined wavelength range, and light-emission by the first light emitting element, the second light emitting element, and the at least two types of phosphors produces white light.

With the present disclosure, a light emitting apparatus that facilitates chromaticity adjustment is realized.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external perspective view of a light emitting apparatus according to Embodiment 1.

FIG. 2 is a plan view of the light emitting apparatus according to Embodiment 1.

FIG. 3 is a cross-sectional view of the light emitting apparatus, taken along A-A in FIG. 2.

FIG. 4 is a chromaticity coordinate diagram for describing chromaticity adjustment in the light emitting apparatus according to Embodiment 1.

FIG. 5 is a diagram illustrating an example of an emission spectrum of the light emitting apparatus according to Embodiment 1.

FIG. 6 is a plan view of a light emitting apparatus according to a modification.

FIG. 7 is a diagram illustrating an outline of a configuration of a light bulb shaped lamp according to Embodiment 2.

FIG. 8 is a sectional view of a lighting apparatus according to Embodiment 3.

FIG. 9 is an external perspective view of the lighting apparatus and its peripheral components according to Embodiment 3.

FIG. 10 is a first diagram illustrating a connection example of LED chips.

FIG. 11 is a second diagram illustrating a connection example of LED chips.

### DETAILED DESCRIPTION OF THE PREFERRED EMBODIMENTS

Hereinafter, a light emitting apparatus, etc., according to exemplary embodiments are to be described; with reference to the accompanying drawings. The exemplary embodiments described below are each general and specific illustration of the present disclosure. Accordingly, values, shapes, materials, components, and arrangement and connection between the components, steps, and the order of the steps shown in the following exemplary embodiments are merely illustrative and not intended to limit the present disclosure. Therefore, among the components in the exemplary embodiments below, components not recited in any one of the independent claims indicating the top level concept of the present disclosure are described as arbitrary components.

Figures are schematic views and do not necessarily illustrate the present disclosure precisely. In the figures, the same reference signs are used to refer to substantially the same configuration, and thus duplicate description may be omitted or simplified.

### Embodiment 1

### Configuration of Entire Light Emitting Apparatus

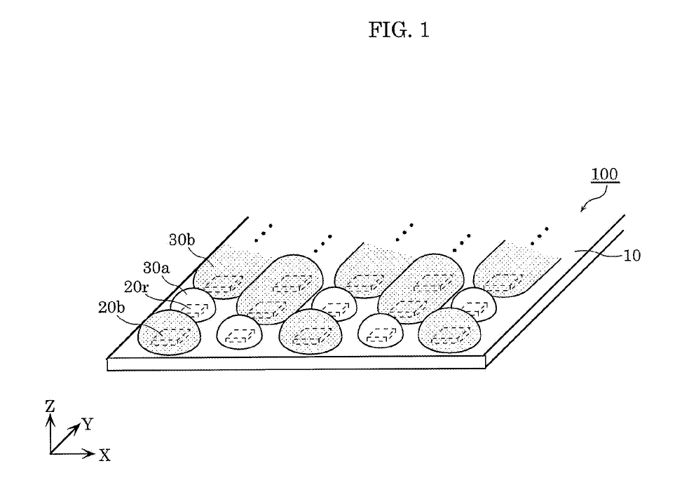

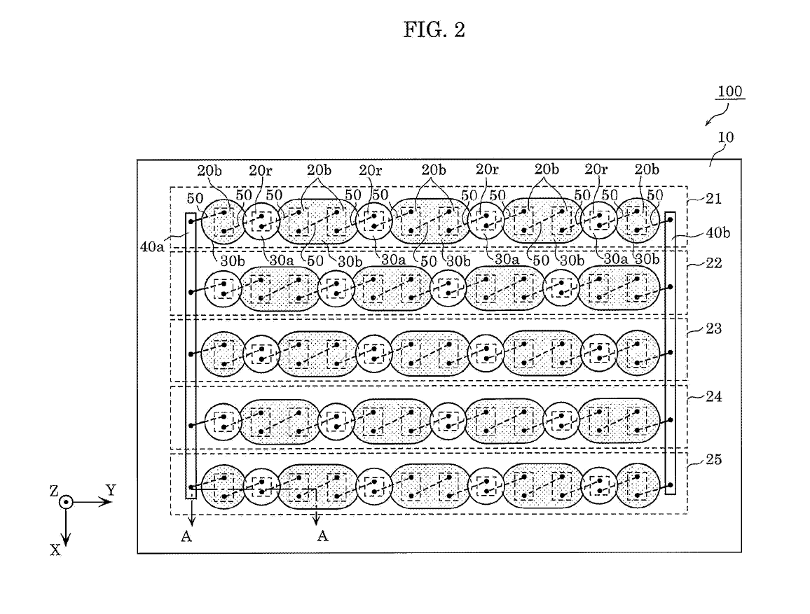

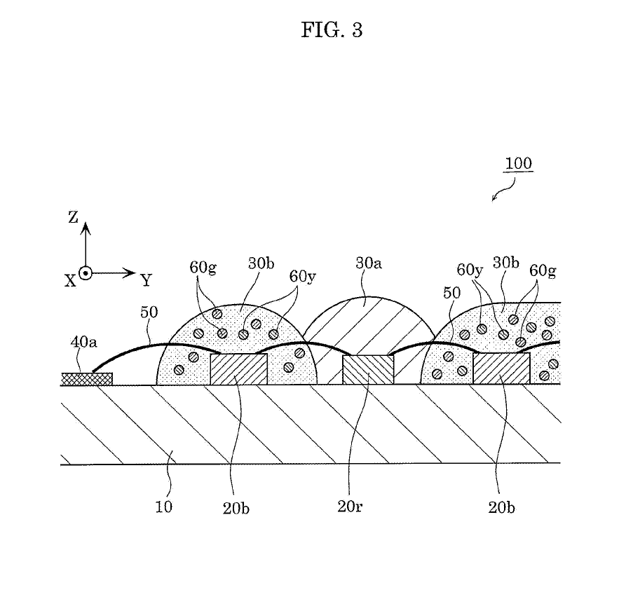

Hereinafter, a configuration of a light emitting apparatus according to Embodiment 1 is described, with reference to the accompanying drawings. FIG. 1 is an external perspective view of the light emitting apparatus according to Embodiment 1. FIG. 2 is a plan view of light emitting apparatus 100 according to Embodiment 1. FIG. 3 is a cross-sectional view of the light emitting apparatus, taken along A-A in FIG. 2. It should be noted that bonding wires are not illustrated in FIG. 1, and the arrangement of the bonding wires is different between FIG. 2 and FIG. 3, for facilitating description.

As illustrated in FIGS. 1 to 3, light emitting apparatus 100 includes substrate 10, and plural light emitting element lines on substrate 10. In Embodiment 1, light emitting apparatus 100 includes five light emitting element lines: light emitting element line 21, light emitting element line 22, light emitting element line 23, light emitting element line 24, and light emitting element line 25.

Each light emitting element line is extending in a Y direction, and includes plural red LED chips 20r and plural blue LED chips 20b. Red LED chip 20r and blue LED chip 20b are different in the emission colors.

As illustrated in FIG. 2, a single light emitting element line includes 12 LED chips. More specifically, a single light emitting element line includes four red LED chips 20r and eight blue LED chips 20b. It should be noted that red LED chip 20r is an example of the first light emitting element, and blue LED chip 20b is an example of the second light emitting element.

LED chips included in a single light emitting element line are arranged along a straight line in the Y direction (the direction of the long side of substrate 10 having a rectangular shape). Furthermore, as illustrated in FIG. 2, LED chips included in each of the light emitting element lines are aligned in an X direction (the direction of the short side of rectangular substrate 10). In other words, substrate 10 includes plural LED chips in a matrix.

As illustrated in FIGS. 2 and 3, in a single light emitting element line, a cathode electrode of a single LED chip is connected to an anode electrode of an LED chip next to the single LED chip via bonding wires 50.

Furthermore, an anode electrode (or a cathode electrode) of an LED chip located at an end of each light emitting element line is connected to line 40a (or line 40b) on substrate 10 via bonding wires 50. Line 40a and line 40b receive supply of power for causing each light emitting element line to emit light. Specifically, the light emitting element lines included in light emitting apparatus 100 are (electrically) connected in parallel with each other.

It should be noted that line 40a, line 40b, and bonding wires 50 comprise a metal material which is one of Au (gold), Ag (silver), and Cu (copper), for example.

In each light emitting element line, red LED chips 20r are sealed with first sealing member 30a separately (in a dot). Furthermore, blue LED chips 20b are sealed along the light emitting element line to which blue LED chips 20b belong, with second sealing member 30b.

First sealing member 30a comprises a transparent resin for example, and the red light emitted from red LED chip 20r is emitted outside from first sealing member 30a without being wavelength-converted (color-converted).

Second sealing member 30b comprises a translucent resin including green phosphor 60g and yellow phosphor 60y as a wavelength conversion material. The blue light emitted from blue LED chip 20b is converted into white light through passing second sealing member 30b.

As described above, light emitting apparatus 100 has a feature that second sealing member 30b includes at least two types of phosphors having different peaks in emission spectra. The advantageous effect brought by second sealing member 30b including at least two types of phosphors will be described later on.

As described above, light emitting apparatus 100 according to Embodiment 1 is what is known as, a COB (chip-on-board) LED module in which LED chips are directly mounted on substrate 10. Hereinafter, each constituent element of light emitting apparatus 100 is to be described.

### [Substrate]

Substrate 10 is, for example, a metal base substrate or a ceramic substrate. Alternatively, substrate 10 may be a resin substrate based on a resin.

If substrate 10 is a ceramic substrate, the ceramic substrate is an alumina substrate comprising aluminum oxide (alumina), or an aluminum nitride substrate comprising aluminum nitride, or the like. If substrate 10 is a metal base substrate, the metal base substrate is an aluminum alloy substrate, an iron alloy substrate, a copper alloy substrate, or the like, which has an insulating film formed on its surface, for example. If substrate 10 is a resin substrate, the resin substrate is, for example, a glass-epoxy substrate comprising fiberglass and an epoxy resin.

For example, substrate 10 may be one that has high optical reflectance (e.g., optical reflectance of 90% or higher). Substrate 10 having high optical reflectance can reflect light emitted by LED chips off the surface of substrate 10. As a result, the efficiency of light emitting apparatus 100 in extracting light is enhanced. Examples of such a substrate include a white ceramic substrate based on alumina.

Alternatively, substrate 10 may be a translucent substrate having high light-transmittance. If substrate 10 is a translucent substrate, light emitted by an LED chip transmits inside substrate 10 and is emitted from a surface (reverse surface) on which an LED chip is not mounted. Examples of such a substrate include a translucent ceramic substrate comprising polycrystalline alumina or aluminum nitride, a transparent glass substrate comprising glass, a quartz substrate comprising quartz, a sapphire substrate comprising sapphire, and a transparent resin substrate comprising a transparent resin material.

While substrate 10 is formed in a rectangular shape in Embodiment 1, it may be formed in any other shape, such as a circular shape.

### [LED Chip and Sealing Member]

As described above, plural red LED chips 20r and plural blue LED chips 20b are on substrate 10.

Each of red LED chip 20r and blue LED chip 20b is a bare chip that emits a visible light of a single color. Red LED chip 20r may be, for example, an LED chip comprising AlGaInP material and having a center wavelength (a peak wavelength of emission spectrum) of 600 nm or greater and 660 nm or less.

Furthermore, blue LED chip 20b is, for example, a gallium-nitride-based LED chip comprising InGaN-based material, having a center wavelength (a peak wavelength of emission spectrum) of 430 nm or greater and 480 nm or less.

First sealing member 30a comprises a translucent resin material such as a silicone resin, and transmits the light from red LED chip 20r and emits the transmitted light to the outside. In other words, first sealing member 30a does not have a wavelength conversion (color conversion) function. First sealing member 30a is included for the purpose of enhancing light emission efficiency of red LED chip 20r by alleviating the refractive index (by reducing the total reflection that occurs when the light is outputted from red LED chip 20r to the air) and protecting red LED chip 20r.

Second sealing member 30b comprises a translucent resin material including green phosphor 60g and yellow phosphor 60y. The translucent resin material is, for example, a silicone resin. Furthermore, green phosphor 60g and yellow phosphor 60y are yttrium aluminum garnet (YAG)-based phosphor (phosphor particle), for example.

According to this, a portion of blue light emitted by blue LED chip 20b is wavelength-converted into green light by green phosphor 60g included in second sealing member 30b. Likewise, a portion of blue light emitted by blue LED chip 20b is wavelength-converted into yellow light by yellow phosphor 60y included in second sealing member 30b. It should be noted that a center wavelength (a center wavelength of emission spectrum) of the green light and a center wavelength of the yellow light are 500 nm or greater and 600 nm or less.

Then, a portion of blue light not absorbed by green phosphor 60g and yellow phosphor 60y, the green light obtained by the wavelength-conversion by green phosphor 60g, and the yellow light obtained by the wavelength-conversion by yellow phosphor 60y are diffused and mixed in second sealing member 30b. This allows second sealing member 30b to output white light.

In contrast, red light is outputted from first sealing member 30a, as described above. Accordingly, light emitting apparatus 100 outputs white light having a higher color rendering resulting from inclusion of components of the red light from first sealing member 30a.

### ADVANTAGEOUS EFFECTS AND OTHERS

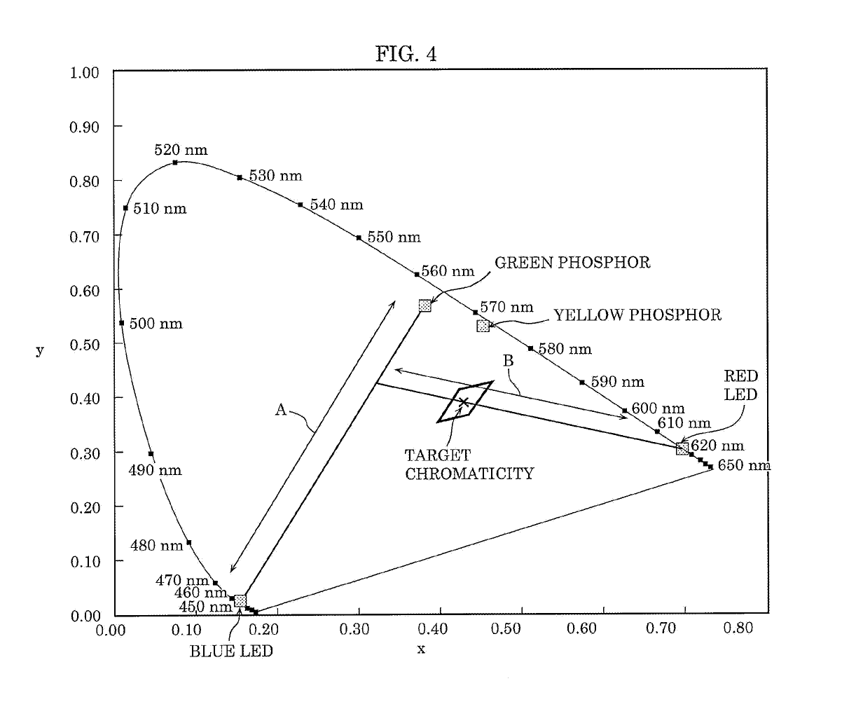

Light emitting apparatus 100 has a feature that second sealing member 30b includes at least two types of phosphors having different peaks in emission spectra. This facilitates matching the chromaticity of light emitting apparatus 100 with the target chromaticity. This advantageous effect will be described below with reference to FIG. 4. FIG. 4 is a chromaticity coordinate diagram for describing chromaticity adjustment in light emitting apparatus 100. In the example in FIG. 4, green phosphor 60g emits green light having the center wavelength of approximately 563 nm, and yellow phosphor 60y emits yellow light having the center wavelength of approximately 572 nm.

In light emitting apparatus 100, by changing an amount of green phosphor 60g or light output of blue LED chip 20b, the chromaticity can be adjusted in the direction indicated by arrow A in FIG. 4 (hereinafter referred to simply as direction A). Here, in order to match the chromaticity of light emitting apparatus 100 with the target chromaticity, chromaticity adjustment in the direction indicated by arrow B in FIG. 4 (hereinafter referred to simply as direction B) is needed, in addition to the chromaticity adjustment in A direction.

Here, a typical way of carrying out the chromaticity adjustment in B direction is to change the brightness of the red light of red LED chip 20r. However, when blue LED chip 20b and red LED chip 20r are connected in series as in light emitting apparatus 100, the light output of blue LED chip 20b and the light output of red LED chip 20r cannot be changed independently. Therefore, the chromaticity adjustment in B direction is carried out by changing the number of red LED chips 20r.

In this case, the chromaticity in B direction is adjusted by a unit of the number of red LED chips 20r, which makes it difficult to carry out fine adjustment on the chromaticity in B direction. It should be noted that the chromaticity adjustment becomes more difficult as the number of light emitting element lines connected in parallel increases (light emitting apparatus 100: five lines).

Here, when second sealing member 30b includes not only green phosphor 60g but also yellow phosphor 60y as in light emitting apparatus 100, it becomes possible to carry out fine chromaticity adjustment in B direction by changing the amount of yellow phosphor 60y.

It should be noted that such an advantageous effect can be obtained by including at least two types of phosphors having different peaks in emission spectra into second sealing member 30b. However, when at least two types of phosphors having peaks in emission spectra significantly different from each other is included, the chromaticity may diverge significantly from the target chromaticity, which makes chromaticity adjustment difficult. There are also cases where the desired light emission efficiency cannot be obtained.

In view of this, phosphors which are not significantly different from each other in peaks in emission spectra are selected for light emitting apparatus 100. Specifically, in light emitting apparatus 100, both the center wavelength of green phosphor 60g and the center wavelength of yellow phosphor 60y belong to a predetermined wavelength range. Here, the predetermined wavelength range is a wavelength range that falls between the center wavelength of red LED chip 20r and the center wavelength of blue LED chip 20b. In Embodiment 1, the predetermined wavelength range is a wavelength range from green to yellow that has a width of approximately 100 nm, namely, a wavelength range of 500 nm or greater and 600 nm or less.

As described above, second sealing member 30b of light emitting apparatus 100 includes at least two types of phosphors. Here, the at least two types of phosphors have peaks in emission spectra within a predetermined wavelength range and have peaks in emission spectra different from each other. Thus, with light emitting apparatus 100, it becomes easier to match the chromaticity with the target chromaticity. In other words, light emitting apparatus 100 is a light emitting apparatus capable of easily adjusting chromaticity. By employing light emitting apparatus 100, a lighting light source and a lighting apparatus having chromaticity adjusted with higher accuracy can be realized.

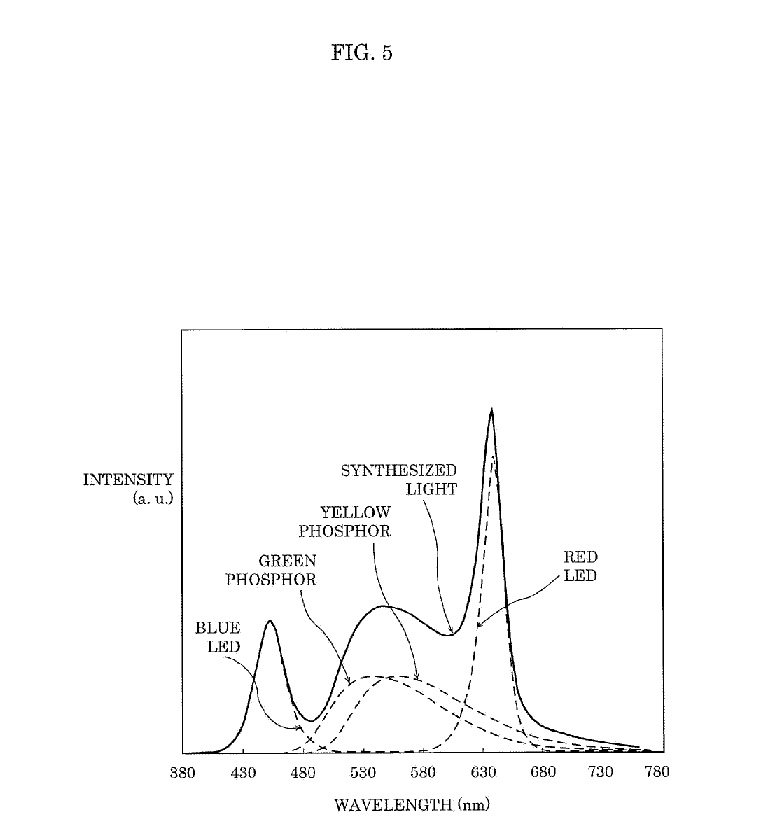

With the above-described structure, in light emitting apparatus 100, red LED chip 20r, blue LED chip 20b, green phosphor 60g, and yellow phosphor 60y emit light and the light is mixed, thereby producing white light (synthesized light) having the spectrum as illustrated in FIG. 5. FIG. 5 is a diagram illustrating an example of an emission spectrum of light emitting apparatus 100.

### [Modification]

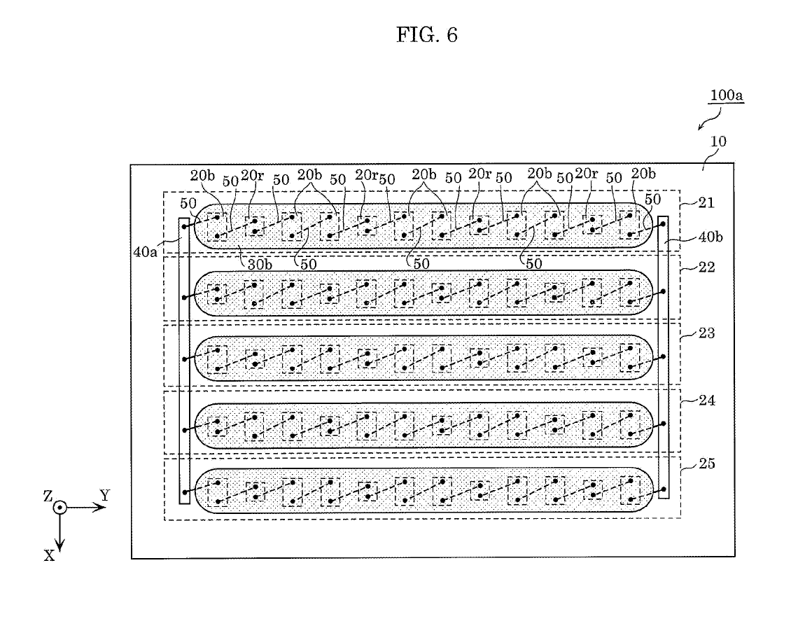

In light emitting apparatus 100, second sealing member 30b sealed only blue LED chip 20b out of red LED chip 20r and blue LED chip 20b. However, only second sealing member 30b may be used as the sealing member in light emitting apparatus 100. In other words, second sealing member 30b may seal both red LED chip 20r and blue LED chip 20b. FIG. 6 is a plan view of a light emitting apparatus in which both red LED chip 20r and blue LED chip 20b are sealed with second sealing member 30b.

In light emitting apparatus 100a illustrated in FIG. 6, each light emitting element line is sealed like a line in an integrated manner, with second sealing member 30b. Here, sealing red LED chip 20r with second sealing member 30b causes no problem, since green phosphor 60g and yellow phosphor 60y are not excited by red light (the wavelength of red light is not converted by green phosphor 60g and yellow phosphor 60y).

In a structure in which sealing member of a single type is used as in light emitting apparatus 100a, there is an advantage that the application (forming) of sealing member can be performed efficiently.

### Embodiment 2

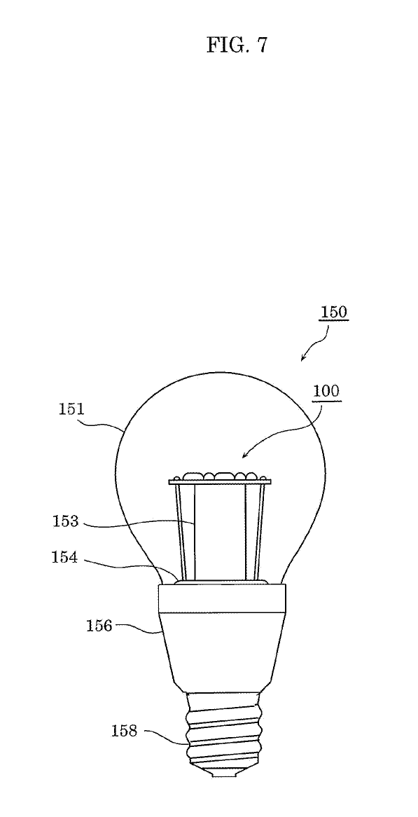

Next, a configuration of a light bulb shaped lamp according to Embodiment 2 will be described, with reference to FIG. 7. FIG. 7 is a diagram illustrating an outline of a structure of light bulb shaped lamp 150 according to Embodiment 2.

Light bulb shaped lamp 150 illustrated in FIG. 7 is an example of the lighting light source, and includes light emitting apparatus 100 as a light source. Light bulb shaped lamp 150 further includes globe 151 which is translucent, chassis 156 which houses a drive circuit for supplying power to light emitting apparatus 100, and base 158 which receives external power. The AC power received by base 158 is converted into DC power by the drive circuit and supplied to light emitting apparatus 100. It should be noted that when DC power is supplied to base 158, the drive circuit may not have DC-to-AC conversion function.

Furthermore, in Embodiment 2, light emitting apparatus 100 is disposed at the center portion of globe 151 by being supported by stem 153. Stem 153 is a metal bar extending inward of glove 151 from a periphery of an opening portion of glove 151.

Specifically, stem 153 is connected to support plate 154 disposed in the periphery of the opening portion of glove 151.

It should be noted that light emitting apparatus 100 may not be supported by stem 153 and may be directly supported by support plate 154. In other words, light emitting apparatus 100 may be attached to a surface facing globe 151 of support plate 154.

Globe 151 is a translucent cover which transmits the light from light emitting apparatus 100 to the outside. It should be noted that globe 151 in Embodiment 2 comprises a material transparent to the light from light emitting apparatus 100. The above-described globe 151 is a glass bulb (clear bulb) made of silica glass which is transparent to visible light, for example.

In this case, light emitting apparatus 100 housed in globe 151 can be seen from outside globe 151.

It should be noted that globe 151 may not be transparent to visible light, and may have light diffusion function. For example, an opaque-white light diffusion film may be formed by applying a resin or white pigment including a light diffusion material, such as silica or calcium carbonate, on the entire inner surface or the entire outer surface of globe 151. Furthermore, the material of globe 151 is not limited to a glass material, and a resin material including a synthetic resin such as acrylic (PMMA) or polycarbonate (PC) may be used.

Furthermore, the shape of globe 151 is not specifically limited. For example, when light emitting apparatus 100 is supported directly by support plate 154 (when stem 153 is not included), globe 151 having a hemisphere shape may be employed.

Above-described light bulb shaped lamp 150 includes light emitting apparatus 100 which facilitates chromaticity adjustment, thereby emitting light at a chromaticity close to the target chromaticity. In other words, light bulb shaped lamp 150 is an lighting light source having chromaticity adjusted with higher accuracy. It is to be noted that light emitting apparatus 100a may be employed for light bulb shaped lamp 150, instead of light emitting apparatus 100.

Although Embodiment 2 has indicated light bulb shaped lamp 150 as an example of the lighting light source, the present disclosure may be realized as another lighting light source such as a straight-tube lamp.

### Embodiment 3

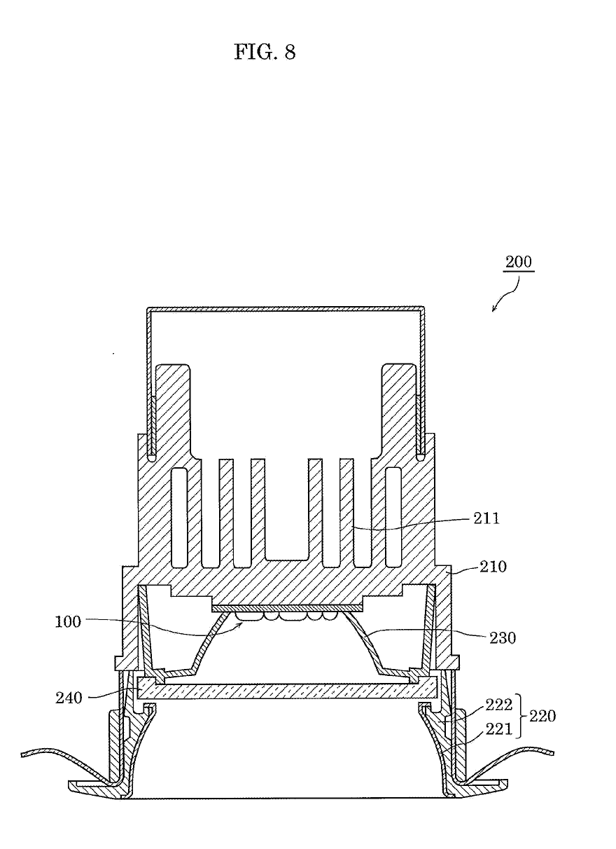

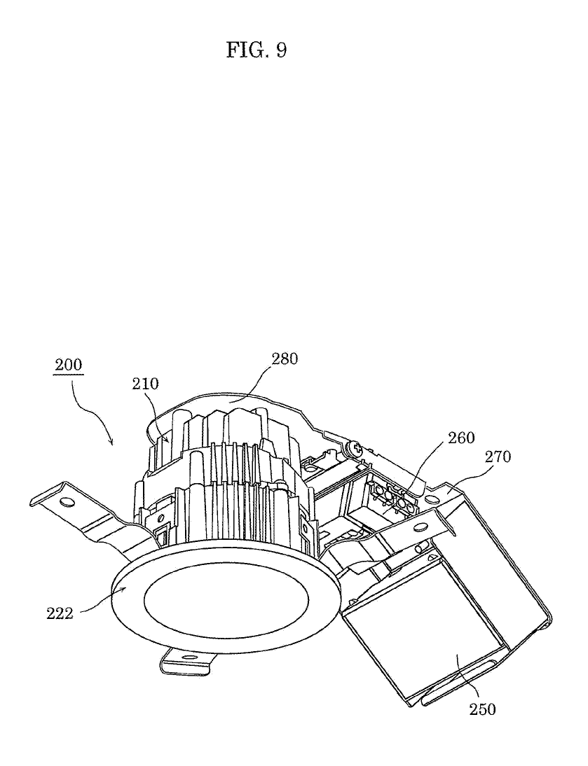

Next, lighting apparatus 200 according to Embodiment 3 is to be described, with reference to FIGS. 8 and 9. FIG. 8 is a sectional view of lighting apparatus 200 according to Embodiment 3. FIG. 9 is an external perspective view of lighting apparatus 200 and its peripheral components according to Embodiment 3.

As shown in FIGS. 8 and 9, lighting apparatus 200 according to Embodiment 3 is, for example, a built-in lighting apparatus, such as a downlight, which is recessed into the ceiling in a house, for example, and emits light in a down direction (to a corridor, a wall, etc.).

Lighting apparatus 200 includes light emitting apparatus 100. Lighting apparatus 200 further includes a body having a substantially-closed-end cylindrical shape, configured of coupling base 210 and frame member 220 being coupled with each other, and reflector 230, and translucent panel 240 which are disposed on the body.

Base 210 is a mounting base on which light emitting apparatus 100 is mounted, serving also as a heat sink for dissipating heat generated by light emitting apparatus 100. Base 210 is formed in a substantially cylindrical shape, using a metallic material. Base 210 is an aluminum die cast product in Embodiment 3.

On top of base 210 (a portion on the ceiling side), a plurality of heat dissipating fins 211 extending upward are disposed, being spaced at regular intervals along a direction. This can efficiently dissipate the heat generated by light emitting apparatus 100.

Frame member 220 includes cone 221 having a substantially-cylindrical shape and a reflective inner surface, and frame body 222 on which cone 221 is mounted. Cone 221 is molded using a metallic material. Cone 221 can be formed by drawing or press forming of aluminum alloy, for example. Frame body 222 is molded of a rigid resin material or a metallic material. Frame member 220 is fixed by frame body 222 mounted on base 210.

Reflector 230 is a ring-shaped (a funnel-shaped) reflective member having internal reflectivity. Reflector 230 can be formed using a metallic material, such as aluminum, for example. It should be noted that reflector 230 may also be formed of, rather than a metallic material, a rigid white resin material.

Translucent panel 240 is a translucent member having light diffusibility and light translucency. Translucent panel 240 is a flat plate disposed between reflector 230 and frame member 220, and mounted onto reflector 230. Translucent panel 240 can be formed in a disk shape, using a transparent resin material, such as acrylic or polycarbonate.

It should be noted that lighting apparatus 200 may not include translucent panel 240. Lighting apparatus 200 not including translucent panel 240 improves luminous flux of the light emitted from lighting apparatus 200.

Also as shown in FIG. 9, lighting apparatus 200 is connected with illumination apparatus 250 which supplies light emitting apparatus 100 with illumination power, and terminal block 260 which relays an alternating-current power from mains supply to illumination apparatus 250.

Illumination apparatus 250 and terminal block 260 are fixed to mounting plate 270 provided separately from the body. Mounting plate 270 is formed by bending a rectangular plate member comprising a metallic material. Illumination apparatus 250 is fixed onto the undersurface of one end portion of mounting plate 270, and terminal block 260 is fixed onto the undersurface of the other end portion. Mounting plate 270 is connected with top plate 280 fixed on top of base 210 of the body.

Lighting apparatus 200 includes light emitting apparatus 100 which facilitates chromaticity adjustment, thereby emitting light at a chromaticity close to the target chromaticity. In other words, lighting apparatus 200 is an lighting apparatus having chromaticity adjusted with higher accuracy. It is to be noted that light emitting apparatus 100a may be employed for light emitting apparatus 200, instead of light emitting apparatus 100.

While the downlight is illustrated as the lighting apparatus in Embodiment 3, the present disclosure may be implemented as any other lighting apparatus, such as a spot light and a ceiling light.

### Other Embodiments

The light emitting apparatus, the lighting light source, and the lighting apparatus according to the exemplary embodiments of the present disclosure have been described above. However, the present disclosure is not limited to the above exemplary embodiments.

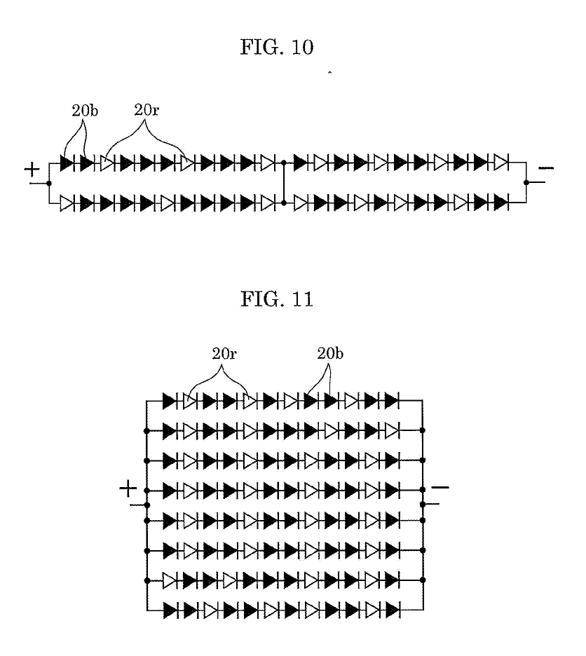

For example, the number of light emitting element lines and the number of LED chips included′ in the light emitting element line are not specifically limited. FIGS. 10 and 11 are diagrams indicating the connection examples of LED chips.

As illustrated in FIG. 10, the light emitting apparatus may include two light emitting element lines each of which including 22 LED chips connected in series. It should be noted that the two light emitting element lines are connected in parallel. In FIG. 10, the ratio between the number of red LED chips 20r and the number of blue LED chips 20b is 7:15.

Furthermore, as illustrated in FIG. 11, the light emitting apparatus may include eight light emitting element lines each of which including 12 LED chips connected in series. It should be noted that the eight light emitting element lines are connected in parallel. In FIG. 11, the ratio between the number of red LED chips 20r and the number of blue LED chips 20b is 1:2.

Furthermore, in the above-described embodiment, each light emitting element line includes two types of light emitting elements: red LED chip 20r and blue LED chip 20b. However, the light emitting element line may include a LED chip (third light emitting element) which has an emission color different from both red LED chip 20a and blue LED chip 20b.

Moreover, in the above exemplary embodiments, the Chip To Chip connection is established between the LED chips (red LED chip 20r and blue LED chip 20b) mounted on substrate 10 through bonding wires 50. The LED chips, however, may be connected to a line (a metal film) on substrate 10 by bonding wires 50, and electrically connected to one another via the line.

Moreover, in the above exemplary embodiments, LED chips are illustrated as light emitting elements included in the light emitting apparatus. However, the light emitting element may be a semiconductor light emitting element, such as a semiconductor laser, or any other type of solid state light-emitting device, such as an electro luminescence (EL) element, including, for example, an organic EL element and an inorganic EL element.

In other instances, various modifications to the exemplary embodiments according to the present disclosure described above that may be conceived by those skilled in the art and embodiments implemented by any combination of the components and functions shown in the exemplary embodiments are also included within the scope of the present disclosure, without departing from the spirit of the present disclosure.

For example, the present disclosure may be realized as a method of manufacturing a light emitting apparatus including sealing the second light emitting element (blue LED chip 20b) with the above-described sealing member including at least two types of phosphors.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light emitting apparatus comprising:
a substrate;
a first light emitting element on the substrate;
a second light emitting element on the substrate, the second light emitting element being connected in series with the first light emitting element and having an emission color different from the first light emitting element; and
a sealing member that includes at least two types of phosphors and seals at least the second light emitting element,
wherein the at least two types of phosphors have different peaks in emission spectra within a predetermined wavelength range, and light-emission by the first light emitting element, the second light emitting element, and the at least two types of phosphors produces white light.

2. The light emitting apparatus according to claim 1,
wherein the light emitting apparatus includes a plurality of light emitting element lines each including the first light emitting element and the second light emitting element, and
the plurality of the light emitting element lines are connected in parallel.

3. The light emitting apparatus according to claim 1,
wherein the first light emitting element emits red light,
the second light emitting element emits blue light, and
the predetermined wavelength range is a wavelength range from green to yellow.

4. The light emitting apparatus according to claim 3,
wherein the at least two types of phosphors include a phosphor which emits green light and a phosphor which emits yellow light.

5. The light emitting apparatus according to claim 3,
wherein the first light emitting element is a red LED having an emission spectrum peak wavelength of 600 nm or greater and 660 nm or less, the second light emitting element is a blue LED having an emission spectrum peak wavelength of 430 nm or greater and 480 nm or less, and
the predetermined wavelength range is a wavelength range of 500 nm or greater and 600 nm or less.

6. The light emitting apparatus according to claim 1,
wherein the sealing member seals only the second light emitting element out of the first light emitting element and the second light emitting element.

7. The light emitting apparatus according to claim 1,
wherein the sealing member seals both the first light emitting element and the second light emitting element.

8. An lighting light source comprising
the light emitting apparatus according to claim 1.

9. An lighting apparatus comprising
the light emitting apparatus according to claim 1.
